(19) United States
(12) Patent Application Publication
(10) Pub. No.: US 2017/0271670 A1
(43) Pub. Date: Sep. 21, 2017

(54) ANODE MATERIALS FOR SODIUM-ION BATTERIES AND METHODS OF MAKING SAME

(71) Applicant: 3M INNOVATIVE PROPERTIES COMPANY, St. Paul, MN (US)

(72) Inventors: Mark N. Obrovac, Halifax, NS (CA); Ryan I. Fielden, Dartmouth, NS (CA); Rommy S. Schuurmans, Halifax, NS, NS (US)

(21) Appl. No.: 15/528,961

(22) PCT Filed: Nov. 18, 2015
(86) PCT No.: PCT/US15/61247

§ 371 Date: May 23, 2017

Related U.S. Application Data
(60) Provisional application No. 62/084,630, filed on Nov. 26, 2014.

(51) Int. Cl. H01M 4/485; H01M 4/38; H01M 10/058; H01M 10/054

(52) U.S. Cl. CPC H01M 4/485; H01M 10/054; H01M 4/381; H01M 10/058; H01M 2004/027

(57) ABSTRACT

An electrochemically active material includes a sodium metal oxide of formula (I): NaₓM_{y}Ti_{z}O₂ (I) In formula (I), 0.2<x<1, M comprises one or more first row transitions metals, 0.1<y<0.9, 0.1<z<0.9; and x+3y+4z=4.

### FIELD

The present disclosure relates to compositions useful in anodes for sodium-ion batteries and methods for preparing and using the same.

### BACKGROUND

Various anode compositions have been introduced for use in secondary sodium-ion batteries. Such compositions are described in, for example, D. A. Stevens and J. R. Dahn, J. Electrochemical Soc., 147 (2000) 1271; Jiangfeng Qian et al., Chem. Commun. 48 (2012) 7070; R. Fielden and M. N. Obrovac, J. Electrochem. Soc. 161 (2014) A1158; Haijun Yu et al., Angewante Chemie 126 (2014) 9109; Ali Darwiche et al., J. Am. Chem. Soc., 134 (2012) 20805; Jiangfeng Qian et al., Angew. Chem. Int. Ed., 52 (2013) 4633; and Hui Xiong et al., J. Phys. Chem. Lett., 2 (2011) 2560.

### SUMMARY

In some embodiments, an electrochemically active material is provided. The material includes a sodium metal oxide of formula (I):

NaₓM_{y}Ti_{z}O₂ (I)

In formula (I), 0.2<x<1, M comprises one or more first row transitions metals, 0.1<y<0.9, 0.1<z<0.9; and x+3y+4z=4.

In some embodiments, a sodium ion battery is provided. The battery includes a cathode comprising sodium, an electrolyte comprising sodium, and an anode comprising the above-described electrochemically active material.

In some embodiments, a method of making a sodium battery is provided. The method includes providing a cathode that includes sodium, providing an anode that includes the above-described electrochemically active material, providing an electrolyte comprising sodium, and incorporating the cathode and anode into a battery comprising the electrolyte. Providing the anode includes combining precursors of the above-described electrochemically active material and ball milling to form the electrochemically active material.

The above summary of the present disclosure is not intended to describe each embodiment of the present invention. The details of one or more embodiments of the disclosure are also set forth in the description below. Other features, objects, and advantages of the invention will be apparent from the description and from the claims.

### BRIEF DESCRIPTION OF THE DRAWINGS

The disclosure may be more completely understood in consideration of the following detailed description of various embodiments of the disclosure in connection with the accompanying figures, in which:

FIG. 1 shows an X-ray diffraction pattern of the sample of Example 1;

FIG. 2 shows the voltage curve of a cell constructed with the negative electrode of Example 1.

FIG. 3 shows an X-ray diffraction pattern of the sample of Example 2;

FIG. 4 shows the voltage curve of a cell constructed with the negative electrode of Example 2.

### DETAILED DESCRIPTION

Sodium ion batteries are of interest as a low-cost, high energy density battery chemistry. Hard carbons have been suggested as suitable negative electrode materials for use in sodium-ion batteries. However, hard carbons have volumetric capacities of only about 450 Ah/L. This is less than two-thirds the volumetric capacity of graphite in a lithium-ion cell.

Alloy based high energy density negative electrode materials have been introduced as an alternative to hard carbons. However, problems with known alloy based electrode materials include large volume expansion during battery operation as a result of sodiation and desodiation, and poor cycle life.

### Definitions

In this document:
the terms “sodiate” and “sodiation” refer to a process for adding sodium to an electrode material;

the terms “desodiate” and “desodiation” refer to a process for removing sodium from an electrode material;

the terms “charge” and “charging” refer to a process for providing electrochemical energy to a cell;

the terms “discharge” and “discharging” refer to a process for removing electrochemical energy from a cell, e.g., when using the cell to perform desired work;

the term “cathode” refers to an electrode (often called the positive electrode) where electrochemical reduction and sodiation occurs during a discharging process;

the term “anode” refers to an electrode (often called the negative electrode) where electrochemical oxidation and desodiation occurs during a discharging process;

the term “alloy” refers to a substance that includes any or all of metals, metalloids, semimetals;

the phrase “P2 crystal structure” refers to a metal oxide composition having a crystal structure consisting of alternating layers of sodium atoms, transition metal atoms and oxygen atoms wherein the sodium atoms reside in prismatic sites and where there are two MO₂ ((M) transition metal) layers in the unit cell. Among these layered cathode materials, the transition metal atoms are located in octahedral sites between oxygen layers, making a MO₂ sheet, and the MO₂ sheets are separated by layers of the alkali metals. They are classified in this way: the structures of layered AₓMO₂ bronzes into groups (P2, O2, O6, P3, O3). The letter indicates the site coordination of the alkali metal A (prismatic (P) or octahedral (O)) and the number gives the number of MO₂ sheets (M) transition metal) in the unit cell. The P2 crystal structure is generally described in Zhonghua Lu, R. A. Donaberger, and J. R. Dahn, Superlattice Ordering of Mn, Ni, and Co in Layered Alkali Transition Metal Oxides with P2, P3, and O3 Structures, Chem. Mater. 2000, 12, 3583-3590, which is incorporated by reference herein in its entirety;

the phrase “O3 crystal structure” refers to a metal oxide composition having a crystal structure consisting of alternating layers of sodium atoms, transition metal atoms and oxygen atoms wherein the sodium atoms reside in prismatic sites and where there are three MO₂ ((M) transition metal) layers in the unit cell. As an example, α-NaFeO₂ (R-3m) structure is an O3 crystal structure (super lattice ordering in the transition metal layers often reduces its symmetry group to C2/m). The terminology O3 crystal structure is also frequently used referring to the layered oxygen structure found in LiCoO₂.

the phrase “electrochemically active material” refers to a material, which can include a single phase or a plurality of phases, that reversibly reacts with sodium under conditions typically encountered during charging and discharging in a sodium-ion battery;

the term “amorphous” refers to a material that lacks the long range atomic order characteristic of crystalline material, as observed by X-ray diffraction or transmission electron microscopy; and

the phrase “nanocrystalline phase” refers to a phase having crystalline grains no greater than about 40 nanometers (nm).

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

In some embodiments, the present disclosure relates to an electrochemically active material for use in a sodium ion battery. For example, the electrochemically active material may be incorporated into a negative electrode for a sodium ion battery.

In some embodiments, the electrochemically active material may include a sodium metal oxide of formula I:

NaₓM_{y}Ti_{z}O₂ (I)

where x+3y+4z=4 and where 0.2<x<1 or 0.4<x<0.75, M includes one or more first row transitions metals, 0.1<y<0.9 or 0.3<y<0.7, and 0.1<z<0.9 or 0.3<z<0.7. The metal oxide may be in the form of a single phase having a P2 or O3 crystal structure. In some embodiments x=y, z=1−x and y+z=1. In some embodiments, M may include one or more of nickel, iron, cobalt, chromium, or copper. In some embodiments, M may include chromium.

In illustrative embodiments, specific examples of sodium metal oxide may include those having the formulae Na_{0.6}Cr_{0.6}Ti_{0.4}O₂, Na_{2/3}Co_{2/3}Ti_{1/3}O₂, Na_{0.6}Mn_{0.6}Ti_{0.4}O₂, Na_{0.5}Fe_{0.5}Ti_{0.5}O₂, Na_{0.6}Ni_{0.6}Ti_{0.4}O₂, and Na_{2/3}Mn_{2/3}Ti_{1/3}O₂.

In some embodiments the transition metal(s) (M) has an average oxidation state of +3. The average oxidation state of M may be calculated by assuming Na is in the +1 oxidation state, Ti is in the +4 oxidation state, O is in the −2 oxidation state, and requiring charge neutrality of the metal oxide of formula I. More precisely, the average oxidation state of M may be determined in terms of the variables x, y, and z in formula I by the formula II:

average oxidation state of M=(4−x−4z)/y (II)

In some embodiments, the present disclosure further relates to negative electrode compositions for sodium ion batteries. The negative electrode compositions may include the above-described electrochemically active material. In some embodiments, the negative electrode compositions of the present disclosure may further include one or more additives such as binders, conductive diluents, fillers, adhesion promoters, thickening agents for coating viscosity modification such as carboxymethylcellulose, polyacrylic acid, polyvinylidene fluoride, lithium polyacrylate, carbon black, and other additives known by those skilled in the art. In some embodiments, the negative electrode compositions may further include other active anode materials, such as hard carbons (up to 10 wt. %, 20 wt. %, 50 wt. % or 70 wt. %, based on the total weight of electrode components, excluding the current collector) as described in D. A. Stevens and J. R. Dahn, J. Electrochem. Soc., 148 (2001) A803.

In some embodiments, the present disclosure is further directed to negative electrodes for use in sodium ion batteries. The negative electrodes may include a current collector having disposed thereon the above-described negative electrode composition. The current collector may be formed of a conductive material such as a metal (e.g., copper, aluminum, nickel).

In some embodiments, the present disclosure further relates to sodium ion batteries. In addition to the above-described negative electrodes, the sodium ion batteries may include a positive electrode, an electrolyte, and a separator. In the cell, the electrolyte may be in contact with both the positive electrode and the negative electrode, and the positive electrode and the negative electrode are not in physical contact with each other; typically, they are separated by a polymeric separator film sandwiched between the electrodes.

In some embodiments, the positive electrode may include a current collector having disposed thereon a positive electrode composition that includes sodium containing materials, such as sodium transition metal oxides of the formula NaₓMO₂, were M is a transition metal and x is from 0.7 to 1.2. Specific examples of suitable cathode materials include NaCrO₂, NaCoO₂, NaMnO₂, NaNiO₂, NaNi_{0.5}Mn_{0.5}O₂, NaMn_{0.5}Fe_{0.5}O₂, NaNi_{1/3}Mn_{1/3}Co_{1/3}O₂, NaNi_{1/3}Fe_{1/3}Mn_{1/3}O₂, NaFe_{1/2}Co_{1/2}O₂, NaMn_{1/2}Co_{1/2}O₂, NaNi_{1/3}Co_{1/3}Fe_{1/3}O₂.

In various embodiments, useful electrolyte compositions may be in the form of a liquid, solid, or gel. The electrolyte compositions may include a salt and a solvent. Examples of solid electrolyte solvents include polymers such as polyethylene oxide, polytetrafluoroethylene, fluorine-containing copolymers, and combinations thereof. Examples of liquid electrolyte solvents include ethylene carbonate, diethyl carbonate, propylene carbonate, fluoroethylene carbonate, and combinations thereof. Examples of electrolyte salts include sodium containing salts, such as NaPF₆ and NaClO₄, Na[N(SO₂CF₃)₂]₂, NaCF₃SO₃ and NaBF₄.

In some embodiments, the sodium ion batteries may further include a microporous separator, such as a microporous material available from Celgard LLC, Charlotte, N.C. The separator may be incorporated into the battery and used to prevent the contact of the negative electrode directly with the positive electrode.

The disclosed sodium ion batteries can be used in a variety of devices including, without limitation, portable computers, tablet displays, personal digital assistants, mobile telephones, motorized devices (e.g., personal or household appliances and vehicles), instruments, illumination devices (e.g., flashlights) and heating devices. One or more sodium ion batteries of this disclosure can be combined to provide battery pack.

The present disclosure further relates to methods of making the above-described electrochemically active materials. In some embodiments, the materials can be made using conventional processes, for example, by heating precursor materials in a furnace, typically at temperatures above 300° C. The atmosphere during the heating process is not limited. The atmosphere can be air, an inert atmosphere, a reducing atmosphere such as one containing hydrogen gas, or a mixture of gases. The precursor materials are also not limited. Suitable precursor materials can be one or more metal oxides, metal carbonates, metal nitrates, metal sulfates, metal chlorides or combinations thereof. Such precursor materials can be combined by grinding, mechanical milling, precipitation from solution, or by other methods known in the art. The precursor material can also be in the form of a sol-gel. After firing, the oxides can be treated with further processing, such as by mechanical milling to achieve an amorphous or nanocrystalline structure, grinding and particle sizing, surface coating, and by other methods known in the art. Exemplary electrochemically active materials can also be prepared by mechanical milling of precursor materials without firing. Suitable milling can be done by using various techniques such as vertical ball milling, horizontal ball milling, or other milling techniques known to those skilled in the art.

The present disclosure further relates to methods of making negative electrodes that include the above-described negative electrode compositions. In some embodiments, the method may include mixing the above-described the electrochemically active materials, along with any additives such as binders, conductive diluents, fillers, adhesion promoters, thickening agents for coating viscosity modification and other additives known by those skilled in the art, in a suitable coating solvent such as water or N-methylpyrrolidinone to form a coating dispersion or coating mixture. The dispersion may be mixed thoroughly and then applied to a foil current collector by any appropriate coating technique such as knife coating, notched bar coating, dip coating, spray coating, electrospray coating, or gravure coating. The current collectors may be thin foils of conductive metals such as, for example, copper, aluminum, stainless steel, or nickel foil. The slurry may be coated onto the current collector foil and then allowed to dry in air or vacuum, and optionally by drying in a heated oven, typically at about 80° to about 300° C. for about an hour to remove the solvent.

The present disclosure further relates to methods of making sodium ion batteries. In various embodiments, the method may include providing a negative electrode as described above, providing a positive electrode that includes sodium, and incorporating the negative electrode and the positive electrode into a battery comprising a sodium-containing electrolyte

In some embodiments, negative electrode compositions that include the electrochemically active materials of the present disclosure can have high specific capacity (mAh/g) retention (i.e., improved cycle life) when incorporated into a sodium ion battery and cycled through multiple charge/discharge cycles. For example, such negative electrode compositions can have a specific capacity of greater than 50 mAh/g, greater than 100 mAh/g, greater than 150 mAh/g, or even greater than 200 mAh/g when the battery is cycled between 0 and 2V or 5 mV and 1.2V vs. Na and the temperature is maintained at about room temperature (25° C.) or at 30° C. or at 60° C. or even higher.

The operation of the present disclosure will be further described with regard to the following detailed examples. These examples are offered to further illustrate various specific embodiments and techniques. It should be understood, however, that many variations and modifications may be made while remaining within the scope of the present disclosure.

### EXAMPLES

### Test Methods and Preparation Procedures

### X-Ray Diffraction (XRD) Test Method

XRD measurement on a powder sample was conducted using an ULTIMA IV X-RAY DIFFRACTOMETER, available from Rigaku Americas Corporation, The Woodlands, Tex., equipped with a Cu anode X-ray tube, and a scintillation detector with a diffracted beam monochromator. Measurements were taken from 10-70 degrees 2-theta, with 0.05 degrees per step, and a 3 second count time.

### Constant Current Cycling Test Method

Constant current cycling of a cell was conducted on a SERIES 4000 AUTOMATED TEST SYSTEM, available from Maccor, Inc., Tulsa, Okla. A cell was cycled at a constant current of C/10, calculated based on a 100 mAh/g capacity for low voltage cycling from 0.005 to 2.2 V.

### Coin Cell Preparation Method

2325 type coin cells were assembled to evaluate electrochemical performance of Na_{0.6}Cr_{0.6}Ti_{0.4}O₂ in sodium cells. The active electrode included Na_{0.6}Cr_{0.6}Ti_{0.4}O₂, Super P carbon black (Erachem Europe), and PVDF (polyvinylidene fluoride, KYNAR PVDF HSV 900, Arkamea, King Of Prussia, Pa.) in an 8:1:1 weight ratio. These components were thoroughly mixed in N-methyl-2-pyrrolidone (anhydrous 99.5%, Sigma Aldrich Corporation, St. Louis, Mo.) with two tungsten carbide balls in a Retsch PM200 rotary mill, available from Retsch GmbH, Haan, Germany. Milling was conducted at 100 rpm for 1 hour to create uniform slurry. The slurry was then coated onto aluminum foil and dried under vacuum at 120° C. for 2 hours. Circular electrodes, 2 cm², were punched from the resulting coated aluminum foil. Coin cell preparation was carried out in an argon filled glove box. Sodium foil disk anodes were punched from 0.015 inch (0.38 mm) thick foil that was rolled from a sodium ingot (ACS reagent grade, Sigma Aldrich). The electrolyte was 1 M NaPF₆ (98%, Sigma Aldrich) dissolved in propylene carbonate (Novolyte Technologies, Inc., Cleveland Ohio). A Celgard 3501 separator, available from Celgard, LLC, Charlotte, N.C., and polyethylene blown microfiber (BMF) separator, 0.1 mm thickness, 1.1 mg/cm², available from 3M Company, St. Paul, Minn. were used as separators.

### Example 1

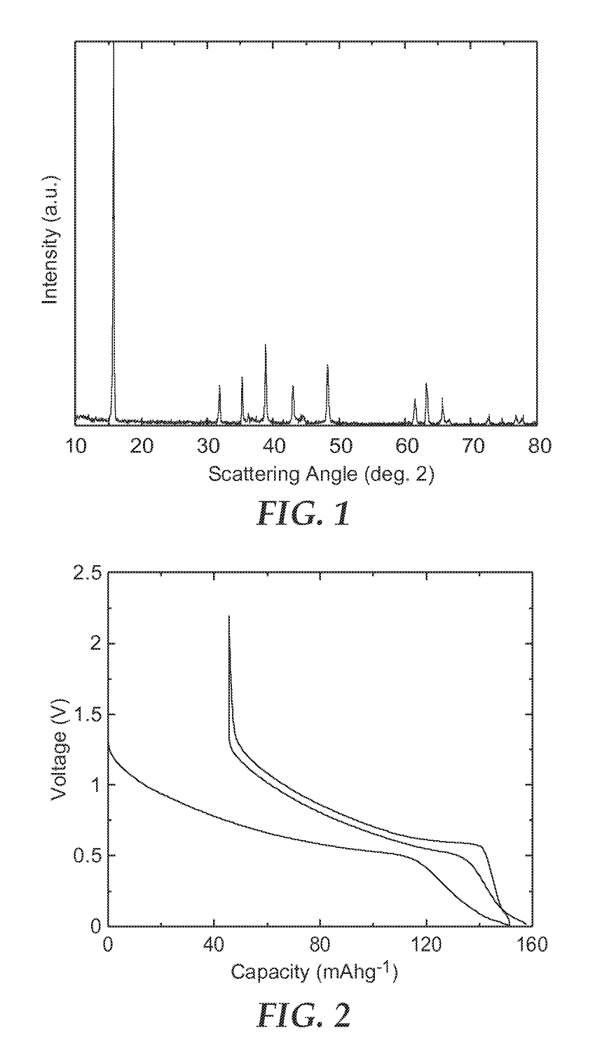

Na_{0.6}Cr_{0.6}Ti_{0.4}O₂ was synthesized by mixing stoichiometric amounts of Na₂CO₃ (99%, Sigma Aldrich), Cr₂O₃ (>98% Sigma Aldrich), and TiO₂ (99%, Sigma Aldrich) via high energy ball milling for ½ hour. A 10% excess of the sodium precursor was added. The powder was then heated at 800° C. for 2 hours and reground and heated for 1 hour at 1000° C. and then transferred directly to an argon filled glovebox. XRD and constant current cycling measurements were made using the previously described test methods. FIG. 1 shows the XRD pattern of the Na_{0.6}Cr_{0.6}Ti_{0.4}O₂ powder sample. Based on the pattern, Na_{0.6}Cr_{0.6}Ti_{0.4}O₂ is phase pure P2. FIG. 2 shows the voltage curve of the Na_{0.6}Cr_{0.6}Ti_{0.4}O₂ sample in the voltage range 0.005-2.2 V.

### Example 2

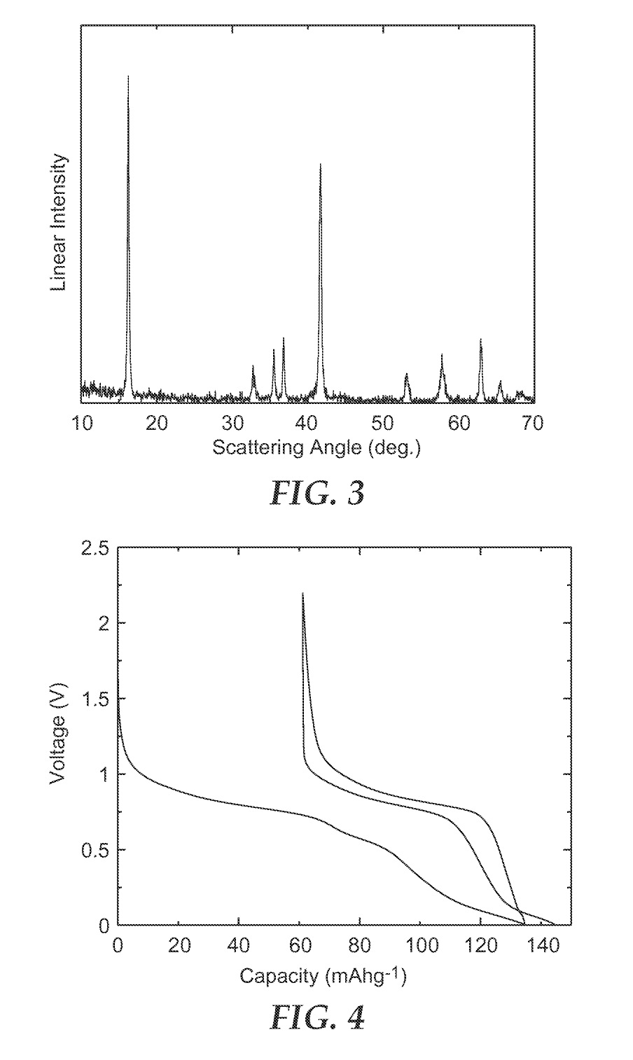

O3 type Na_{0.75}Cr_{0.75}Ti_{0.25}O₂ was synthesized by mixing stoichiometric amounts of Na₂CO₃ (99%, Sigma Aldrich), Cr₂O₃ (>98% Sigma Aldrich), and TiO₂ (99%, Sigma Aldrich) via high energy ball milling for ½ hour. A 10% excess of the sodium precursor was added. The powder was then heated at 1000° C. for 3 hours and then transferred directly to an argon filled glovebox. XRD and coin cell measurements were made using the methods as previously described. FIG. 3 shows the XRD pattern of the Na_{0.75}Cr_{0.75}Ti_{0.25}O₂ sample which has the O3 crystal structure. FIG. 4 shows the voltage curve of the Na_{0.75}Cr_{0.75}Ti_{0.25}O₂ sample in the voltage range 0.005-2.2 V.

1. An electrochemically active material, the material comprising:
a sodium metal oxide of formula (I):
NaₓM_{y}Ti_{z}O₂ (I)
wherein 0.2<x<1, M comprises one or more first row transitions metals,
0.1<y<0.9, and 0.1<z<0.9; and
wherein x+3y+4z=4; and
wherein M comprises chromium.

2. The electrochemically active material of claim 1, wherein the sodium metal oxide is in the form of a single phase having a P2 or O3 crystal structure.

3. The electrochemically active material according to claim 1, wherein M comprises a plurality of first row transition metals.

4. The electrochemically active material according to claim 1, wherein M has an average oxidation state of +3.

5. The electrochemically active material according to claim 1, wherein x=y, z=1−x, and y+z=1.

6. The electrochemically active material according to claim 1, wherein x≦0.75.

7. (canceled)

8. (canceled)

9. A sodium ion battery comprising:
a cathode comprising sodium;
an electrolyte comprising sodium; and
an anode comprising an electrochemically active material comprising a sodium metal oxide of formula (I):
NaₓM_{y}Ti_{z}O₂ (I)
wherein 0.2<x<1, M comprises one or more first row transitions metals, 0.1<y<0.9, and 0.1<z<0.9; and
wherein x+3y+4z=4.

10. An electronic device comprising a sodium ion battery according to claim 9.

11. A method of making a sodium battery, the method comprising:
providing a cathode comprising sodium;
providing an anode, wherein providing the anode comprises combining precursors of an electrochemically active material comprising a sodium metal oxide of formula (I):
NaₓM_{y}Ti_{z}O₂ (I)
wherein 0.2<x<1, M comprises one or more first row transitions metals, 0.1<y<0.9, and 0.1<z<0.9; and
wherein x+3y+4z=4
and ball milling the precursors;
providing an electrolyte comprising sodium; and
incorporating the cathode and anode into a battery comprising the electrolyte.
